(19) United States
(12) Patent Application Publication
(10) Pub. No.: US 2005/0125792 A1
(43) Pub. Date: Jun. 9, 2005

(54) Software materialization platform and an artificial neuron computer system

(76) Inventors: Che-An Chang, Taipei (TW); Shu-Wei Chang, Taipei (TW); Tze-Hao Chang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/728,870

(22) Filed: Dec. 8, 2003

(51) Int. Cl. G06F 15/18; G06F 9/46

(52) U.S. Cl. 718/100

(57) ABSTRACT

A software materialization process and an artificial neuron computer system, refer to a hardware platform for the materialization and auto-integration of an application software, comprises primary functions of providing a physical platform for application software development and plug-in integration. By employing the improved technique of the hardware platform, the development of an application program can be modularized, simplified, materialized, and can automate the integration of the application system such that the application system development horizon can be shortened, and the obsession from integrating network, operating systems, and application software can be avoided, and the cost of the enterprise electronization can be mitigated, and the persecution caused by lacking of human talents and capability can be released. Accordingly, a automatic physical platform is provided to enable the user's application software plugging directly in the physical platform without the so-called integration troubles.

### BACKGROUND OF THE INVENTION

1. Field of the Invention

The present system relates to a software materialization platform and an artificial neuron computer system. More specifically, the present invention relates to a computer system based on an idea of software materialization and artificial neuron, which avoids the use the development and integration mode of conventional software systems, but utilizes the concept of auto-integration and the application of modularization to lower the cost of the enterprise electronization, and to shorten the time of the development and integration of the application software, as well as to reduce the obsession of the system maintenance and the operation risk.

2. Description of the Prior Art

In view of the timetable for the development of a conventional computerization project, to implement an application system typically requires a number of engineers with various professions, such as system analysts, programmers, system engineers, hardware engineers, network engineers, etc., who have to undergo unceasingly coordinating, discussing, and integrating before reaching the conclusion and the implementation. In another word, the fulfillment of an application system is the baby of a group of persons with attentiveness and painstaking care. In which, inter alia, the choice of the computer platform is decisive to the success or not of the professional talent of every project participant and the implementation of the system. For instance, if the user decides to use the open system Unix/Linux/Zenix platform, it will be an ordeal for the engineer proficient at a Microsoft platform. Different requirement from different users may affects directly the operating cost of a software development vendor and the quality of the project implementation. In terms of the conventional process for data processing, as shown in FIG. 3, a simple data processing model might become vary complex in a computerized process, as shown in FIG. 4. Accordingly, these indicates that, in order to fulfill a system, it requires the assistance from a group of computer engineers with various processions, include:
1. a network engineer understanding the communication principles for assisting the setup of the network and writing the communication programs;
2. a system engineer understanding the operating system for assisting the setup of the system, adjusting the performance of the whole system, and the like;
3. a analyst understanding the features of the proprietary industry for assisting the analysis of the system and writing specifications;
4. a programmer understanding the program design and the operating system features for writing the data processing programs; and
5. other.

However, the work of each participant is relevant intimately to the success or not of the project. Such a situation creates a large deviation from the expectation of the computerization. Even if the project can be implemented and gone alive, other headachy problems may emerge from the system maintenance, modification and management of the software and/or hardware. It might be arguable on whether such a result is reasonable or not. Nevertheless, in a data processing flow, as shown in FIG. 5, a complex process may be required for just sending a simple specific string of words into a certain specific program or a specific modular data processor.

Accordingly, it can be seen that the above-described conventional processing flow still have many drawbacks, are not well designed, and need to be improved urgently.

In view of above-described disadvantages derived from the conventional processing flow, the present inventor had devoted to improve and innovate, and, after studying intensively for many years, developed successfully a software materialization platform and an artificial neuron computer according to the invention.

### SUMMARY OF THE INVENTION

Accordingly, one object of the invention is to provide a software materialization platform, characterized in that, as shown in the data process model illustrated in FIG. 6, it is intended to use some specific program modules in a simplest manner sufficient to integrate a complex application, and thus the cost and risk of an enterprise computerization can be reduced; and that, as shown in FIG. 7, only one CPU (central processing modular), one simple operating system or one start-up logic circuit for starting up some build-in program modules, is required for receiving data to be processed from network or other input channels, and sending data to an modular data processor or IC card equipped with a small-scale CPU, memory and a section of data processing program, to accomplish sufficiently the whole process of data processing.

The advantages of using the software materialization platform of the instant invention are described as follows:
1. From users' view, all elements in the black box are constant system elements, build-in software modules are setup already, and no more concept of complex operating system involved. The system employed is an equipment just like a router, and do not has problems of sophisticated system management and maintenance, and thus significantly reduce the cost of setup and maintenance for the enterprise computerization.
2. From the view of the system, the black box has constant components. The black box is responsible only for interpreting the format of input data and managing the channel establishment for data exchange, whereas it is the application program of modular data processing that handles the actual data processing, as shown in FIG. 8. Therefore, since there is no complex operating system, the stabilization of the black box can be raised.
3. From the view of the programmer, for the interface of sending/receiving data, the present system provides four data sending/receiving interfaces such that the programmer can use those four data transmission interface (API) to achieve (1) reading the data to be processed from the outstanding data register in the black box, as shown in FIG. 9; (2) calling and using by reference any modular data processor plugged in the black box or sending the inter-system data, as shown in FIG. 10; For the programmer, he/she do not need to know how the black box operates. Further, since no concept of the operating system is acquired that enable more flexibility to code programs for the programmer. Viewing the current operating systems, such as the mainframe operating system and open system (Unix/Linux) or Microsoft window system, the features of the operating system can affect greatly the way of program coding. For instance, the open system provides multi-process programming (Fork process) or so-called Daemon, which do not exist in the Microsoft window system; there are a lot of such examples perplexing the programmers; Unfortunately, the extent of understanding about the feature of the operating system by the programmer can affect the stability of the program he written. More unfortunately, in the current project development, every program associated with the application system affects frequently the success or not of the implementation of the application system, where thy are not easy to be tested and divided. This accounts for another important reason to emphasize the modularization of the program. Furthermore, in view of the program development tool, no matter what kind of programming language the programmer proficient, such as C/C++/Cobot/FORTRAN/PASC AL/JAVA, as long as the program is an file (.EXE) executable in the modular data processor, it doesn't matter which kind of the programming language is used to write that file.
4. From the view of system integration, it is difficult to train up a network engineer or a competent system engineer, where, besides a substantially solid concept of the computer operating system, it is also required to have a practical experience and flexible mind, discerning about what is TCP/IP?, what is SNA?, what is X.25?, what is SWAP?, what is DHCP?, and the like. An operating system typically is a product achieved for many years by efforts of hundreds, even thousands, persons, so it is difficult for a person to learn it throughout, and to tune and modify the system, and especially, it is not quite easy to find an competent person. In the concept of the system design of the present invention, it is intended to simplify the system for having the automation of the system operations more easily, even do not require the manual intervention. The inside of the black box seldom requires changing and it is the user program plugged in the device changeable; the content of the user program decides the function of the black box.
5. From the view of system analyst, it can be seen from the course of the current system development that the application system can not go alive just because of the some failed functions within the application system. Such kind of result is unfair to anyone and might embarrass its users. This may result in taking more months even years to re-find another development vendor to redevelop a useful application system.

In the system design of the present invention, the application is already modularized to some extent such that the user does not need to re-start the project due to few failed functions. The modular design can lead the modification, mounting or un-mounting of the application system to become more flexible.

As seen from the above-described phenomena, in fact, the computerization and electronization of an enterprise has high barriers and high risks. Not only it is costly to purchase the software and the hardware equipments, but also there are subsequent problems of maintenance, management and personnel training.

B. The Artificial Neuron Computer System

In current existing systems, it is difficult to manage and maintain a system and become more complex while a number of computers form a service group requires integrating the system and managing the network and coordinating the various applications. As the current system, it is quite difficult to integrate the inter-system transactions. In our design, it is intended to have each computer in the group learning each other, as illustrated in FIG. 11. Once any computer in the service group receives data whose format can not be interpreted, it can find out the program capable of interpreting the data format and processing the data in the group, as shown in FIG. 12. Such design can make the integration of the applications more flexible and the user can add or remove programs at any time and can set the modifying procedure without the network configuration system.

The objects of the software materialization platform and the artificial neuron computer system according to the present invention are to provide the reduction of the cost of enterprise electronization and mitigating the risk of enterprise computerization process as well as eliminating the obsessions of management, maintenance and human-power requirements to the utmost after computerization.

### BRIEF DESCRIPTION OF THE DRAWINGS

The drawings disclose an illustrative embodiment of the present invention, which serves to exemplify the various advantages and objects hereof, and are as follows:

FIG. 1 shows the software materialized platform architecture diagram of the software materialization platform and the artificial neuron computer system according to the present invention;

FIG. 1A is a schematic flow diagram illustrating the implementation of modularization of the application system of the software materialization platform and the artificial neuron computer system according to the present invention;

FIG. 2 shows the system architecture diagram of the software materialization platform and the artificial neuron computer system according to the present invention;

FIG. 3 is a flow chart illustrating data processing;

FIG. 4 shows the flow chart of computerized data processing;

FIG. 5 shows the flow chart of data processing;

FIG. 6 is a flow chart illustrating data processing model of the software materialization platform and the artificial neuron computer system according to the present invention;

FIG. 7 shows the data processing architecture diagram of the software materialization platform and the artificial neuron computer system according to the present invention;

FIG. 8 is a flow chart illustrating the data interpretation of the black box of the software materialization platform and the artificial neuron computer system according to the present invention.

FIG. 9 is a flow chart illustrating reading of the outstanding data by the black box of the software materialization platform and the artificial neuron computer system according to the present invention;

FIG. 10 is a flow chart illustrating the calling of each modular data processor in the black box and send data to the inter-system by the software materialization platform and the artificial neuron computer system according to the present invention;

FIG. 11 shows a schematic diagram of the computer in the group learning each other by the software materialization platform and the artificial neuron computer system according to the present invention.

FIG. 12 shows the flow chart of a computer in the group receives data whose format can not be interpreted of the software materialization platform and the artificial neuron computer system according to the present invention.

FIG. 13 shows the system architecture diagram of the software materialization platform according to the present invention;

FIG. 14 shows the schematic diagram of the general program coding manner;

FIG. 15 shows the schematic diagram of the program coding manner of the software materialization platform according to the present invention;

FIG. 16 shows the schematic diagram of the configuration file of the software materialization platform according to the present invention;

FIG. 17 shows the schematic diagram of the start-up of the server program of the software materialization platform according to the present invention;

FIG. 18 shows the schematic diagram illustrating data receiving from the internet by the communication server of the software materialization platform according to the present invention;

FIG. 19 is a flow chart illustrating the data dispatcher dispatching the data received from the communication server to the modular processor of the system of the software materialization platform according to the present invention;

FIG. 20 shows a schematic diagram of the data format and the device name file of the build-in database access module of the software materialization platform according to the present invention;

FIG. 21 is a flow chart illustrating the loading of the configuration file into memory while the system starting up, of the software materialization platform according to the present invention;

FIG. 22 is a schematic flow chart illustrating the implementation of the data register of the software materialization platform according to the present invention;

FIG. 23 is a flow chart illustrating the implementation of the internal & external devices of the software materialization platform according to the present invention;

FIG. 24 is a flow chart illustrating the implementation of the modular data processor of the software materialization platform according to the present invention;

FIG. 25 is a flow chart illustrating the implementation of the simple operating system of the software materialization platform according to the present invention;

FIG. 26 is a schematic flow chart illustrating the implementation of the system monitor of the software materialization platform according to the present invention;

FIG. 27 shows the architecture diagram of the implementation of the software materialization platform and the artificial neuron computer system according to the present invention; and

FIG. 28 is a schematic flow chart illustrating the implementation of the artificial neuron computer system of the software materialization platform and the artificial neuron computer system according to the present invention.

### DETAILED DESCRIPTION OF THE PREFERRED EMBODIMENT

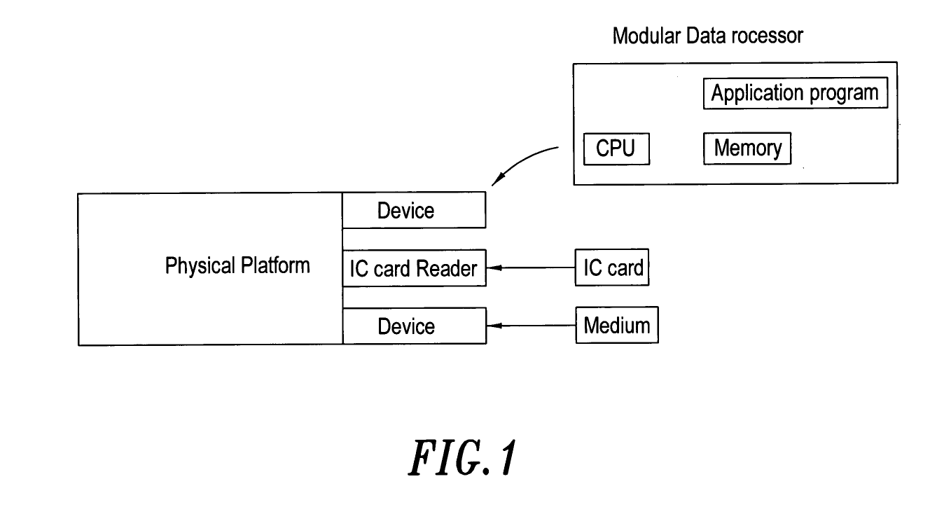

The present system relates to a data processing computer system. More specifically, the present invention relates to a computer system based on an idea of software materialization and an artificial neuron. The present invention takes off the current software development and system integration model, employs the concept of auto-integration and modularizing data processing to shorten the timetable of the enterprise electronization and lowers the risk of management, maintenance, expansion and integration after computerization, and reduces the cost of the enterprise electronization and operating risks. It is intended to raise the willingness of the enterprise computerization in the most convenient way. Please refer to FIG. 1, the software materialized platform architecture diagram of the software materialization and the artificial neuron computer system according to the present invention, through the improvement of the computer hardware platform, it is intended to enable the user to modularize the application, and load the executable file (.EXE) into the modular data processor or the IC card capable of executing programs, and plug the device with the execution file into the device of the improved computer platform for waiting the outstanding data and processing them. The data processing log can be saved into the medium (e.g. a thumb drive or an external hard disk) plugged on the improved computer platform. Regarding with the modularizing of the application system, as shown in FIG. 1A, the modularization of the program can have the coding and change of the program become more independent and the system in the whole will not be affected by the change or the creation of a single program. This enable hereafter the maintenance and integration of the system become more flexible and convenient, and thus greatly mitigate the cost and risk from maintaining system construction.

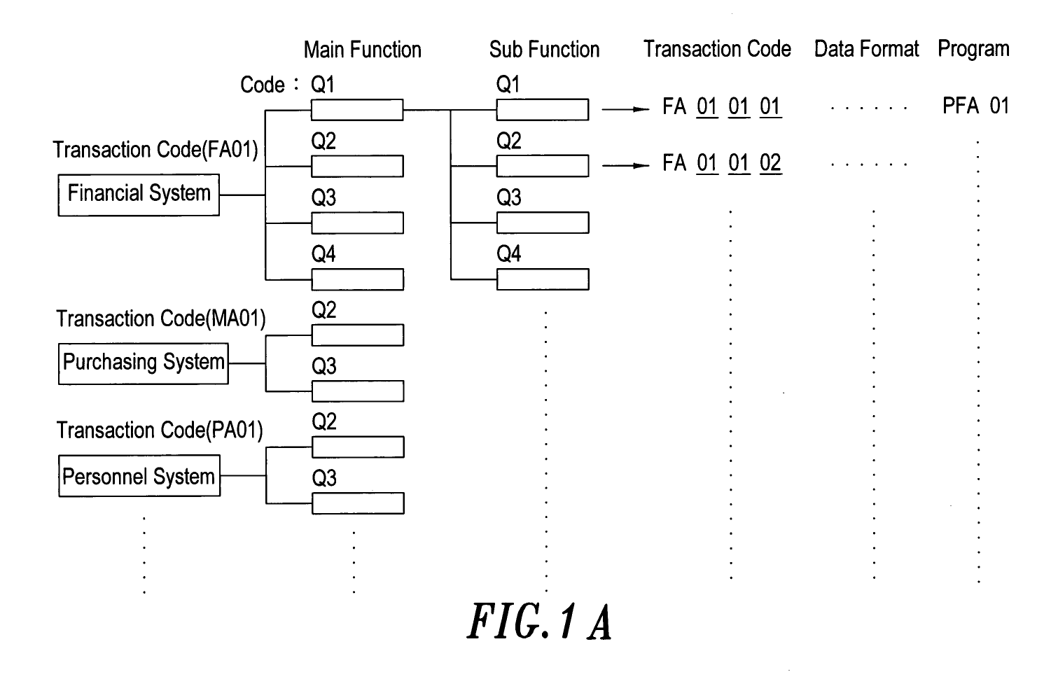

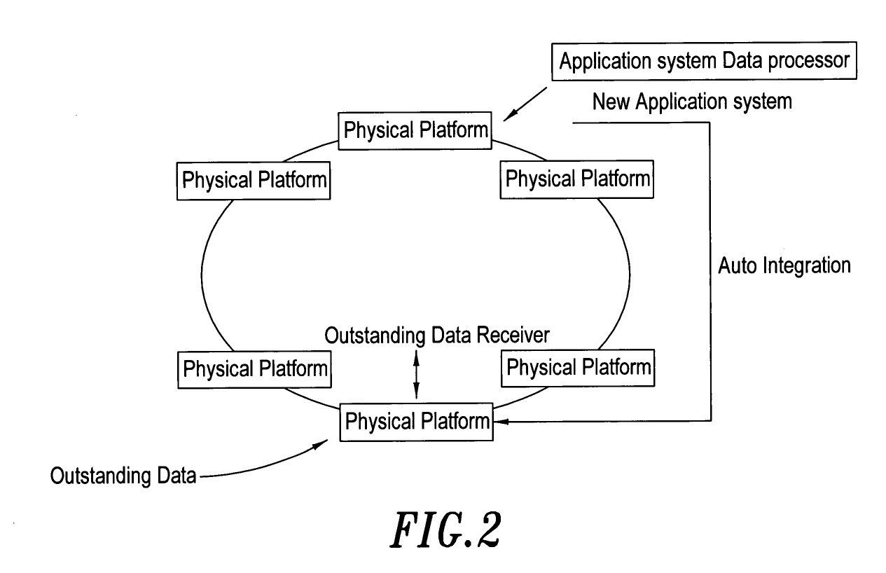

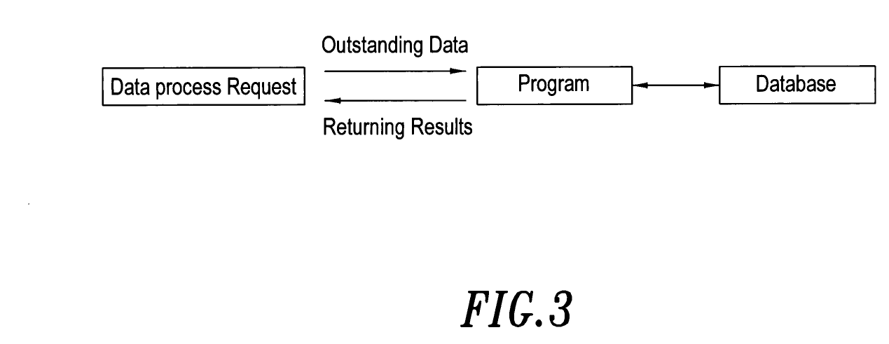

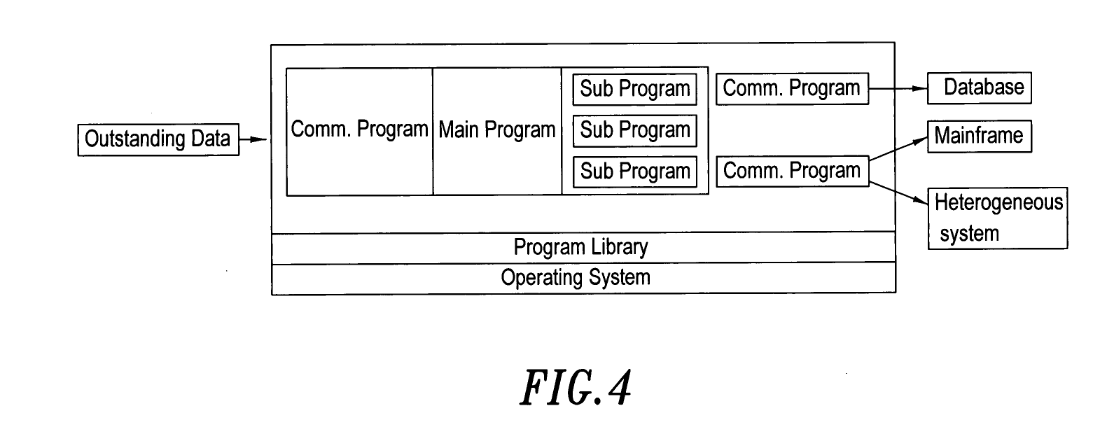

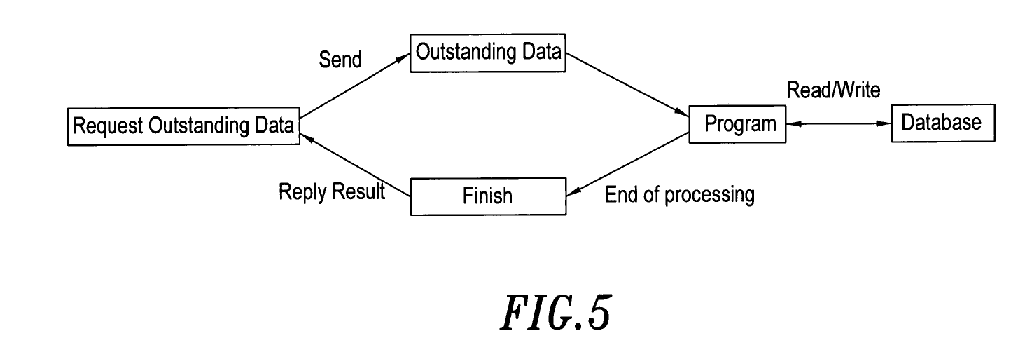

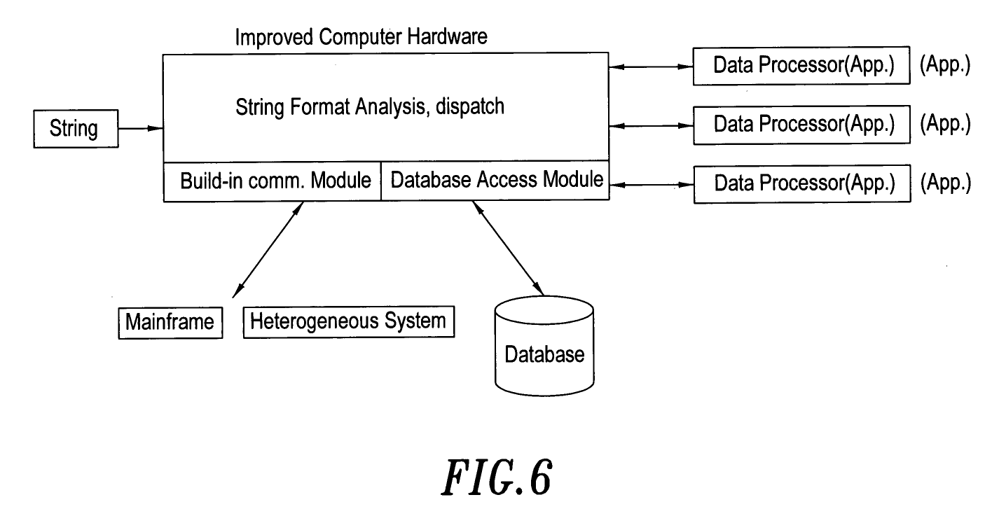

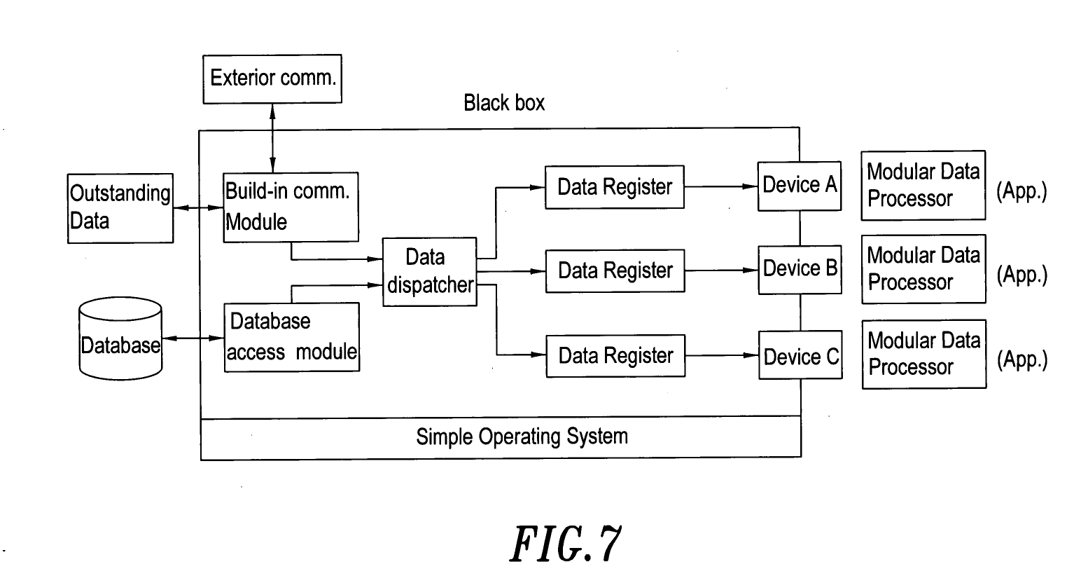

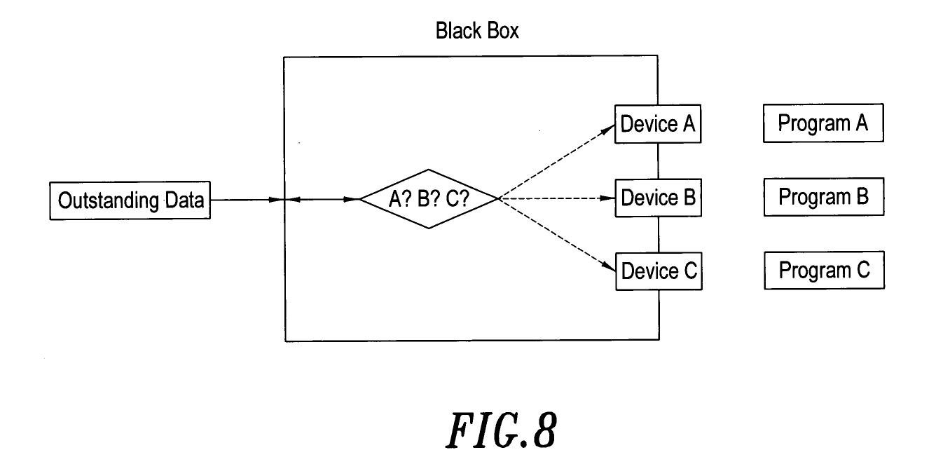

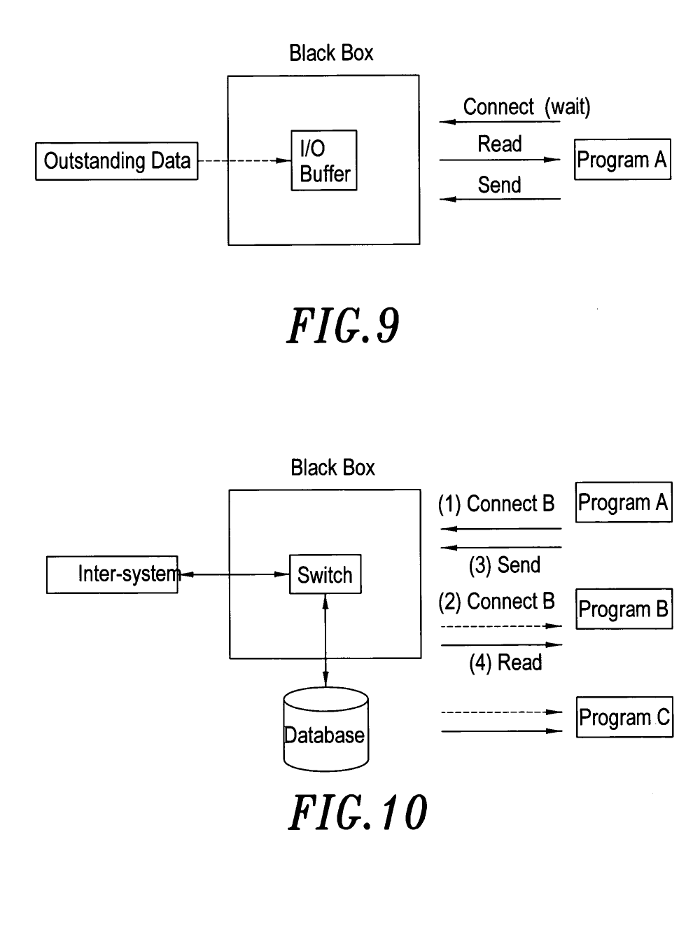

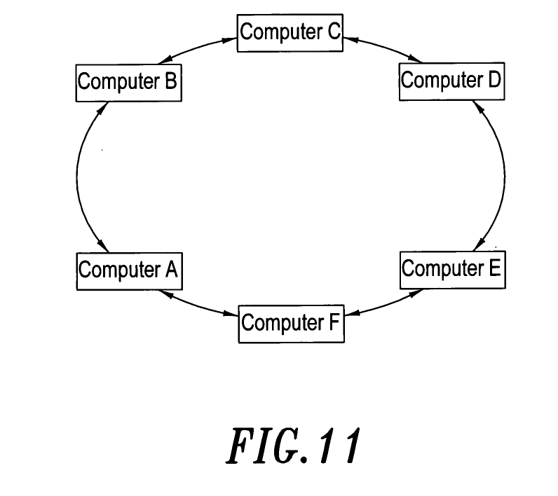

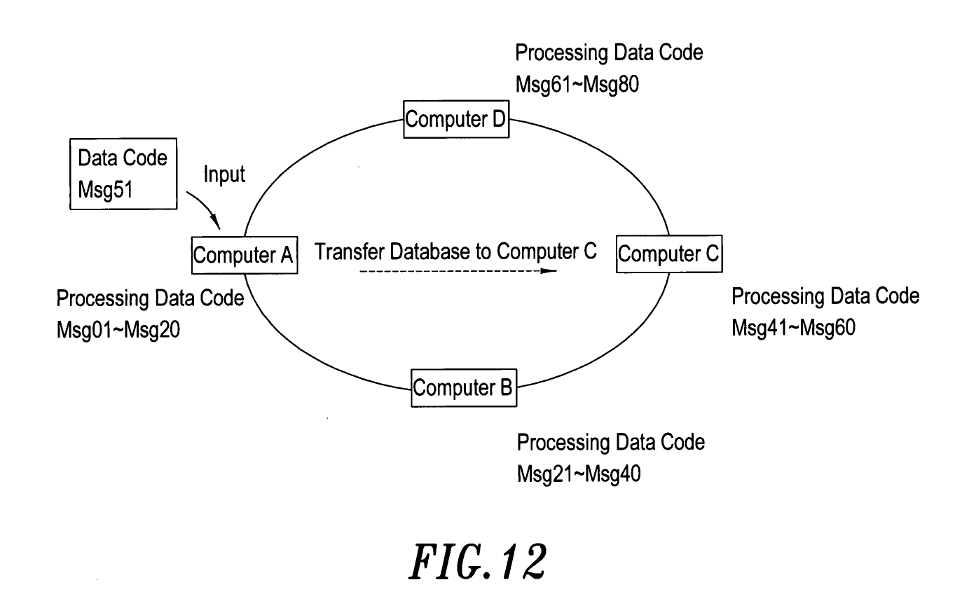

Please refer to FIG. 2, the artificial neuron computer system architecture diagram of the software materialization and the neuron computer system according to the present invention. For a new system or program, the user can subscribe the new program into a new modular data processor or an IC card, and plug directly in a any device of any improved computer platform in the same group, and the improved computer platform automatically integrates the new modular processor or IC card with the current system and have it to wait for the input of the outstanding data. So the application system becomes more simple and convenient to add, modify, maintain, and the whole operation of the system will not be affected by any minor change, and thus significantly reduce the cost and risk of the integration and maintenance of the system.

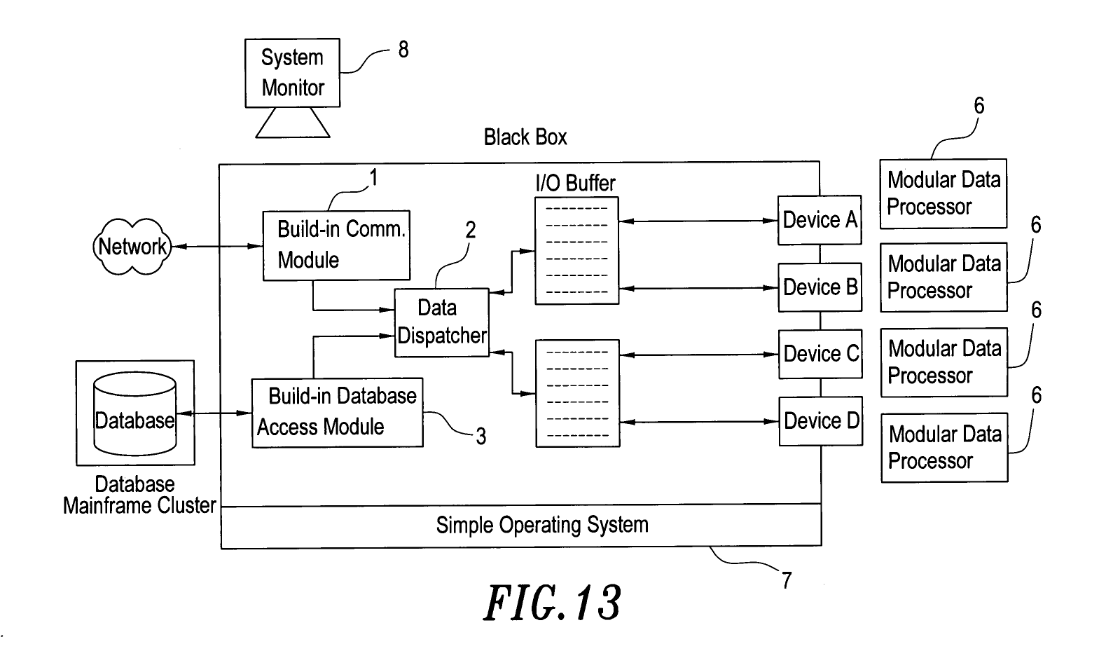

Please refer to FIG. 13, the system architecture diagram of the software materialization according to the present invention comprise.

A build-in communication module1, said build-in communication module is a duplex communication module programmed and burned in the system EPROM such that parameters can be configured by the user to generate a corresponding server program for receiving the outstanding data from the network. The protocol module includes TCP/IP, X.25, ASYNC, SNA (a proprietary communication protocol of IBM computer product series). The coding way of the build-in communication module is not the same with the conventional communication program, as illustrated by way of an example of the TCP/IP communication as follows.

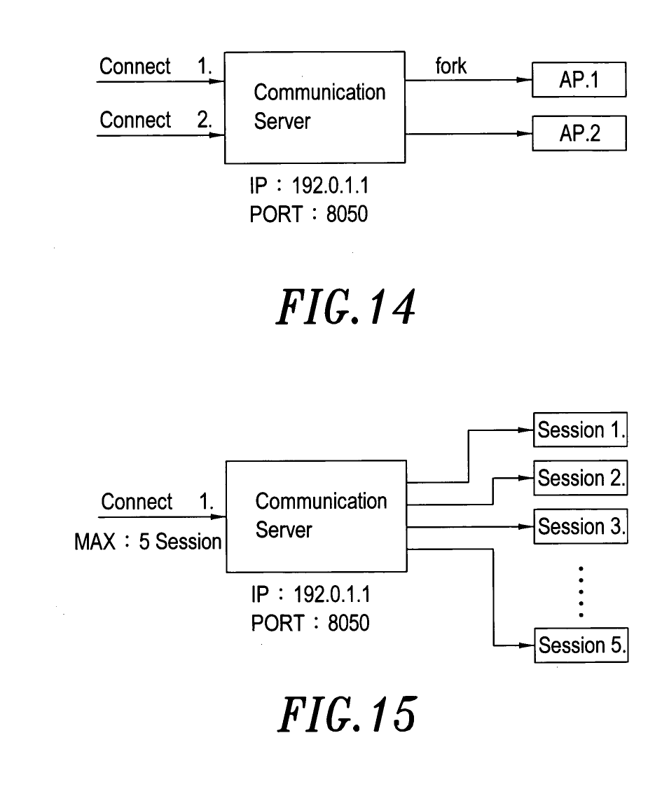

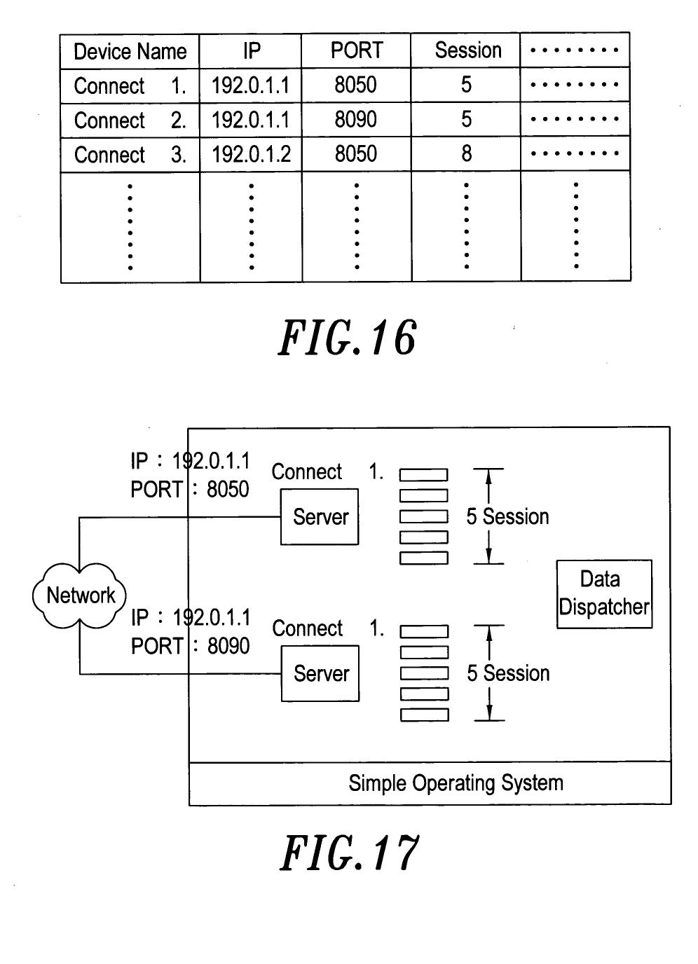

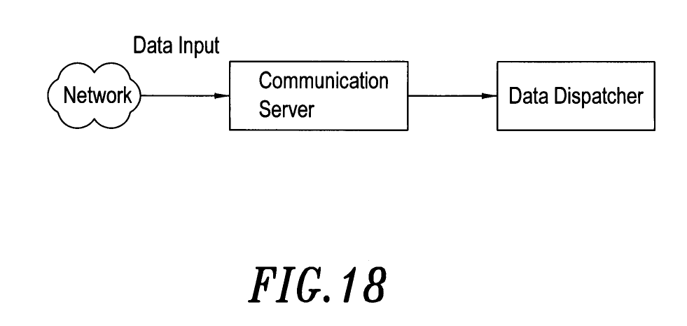

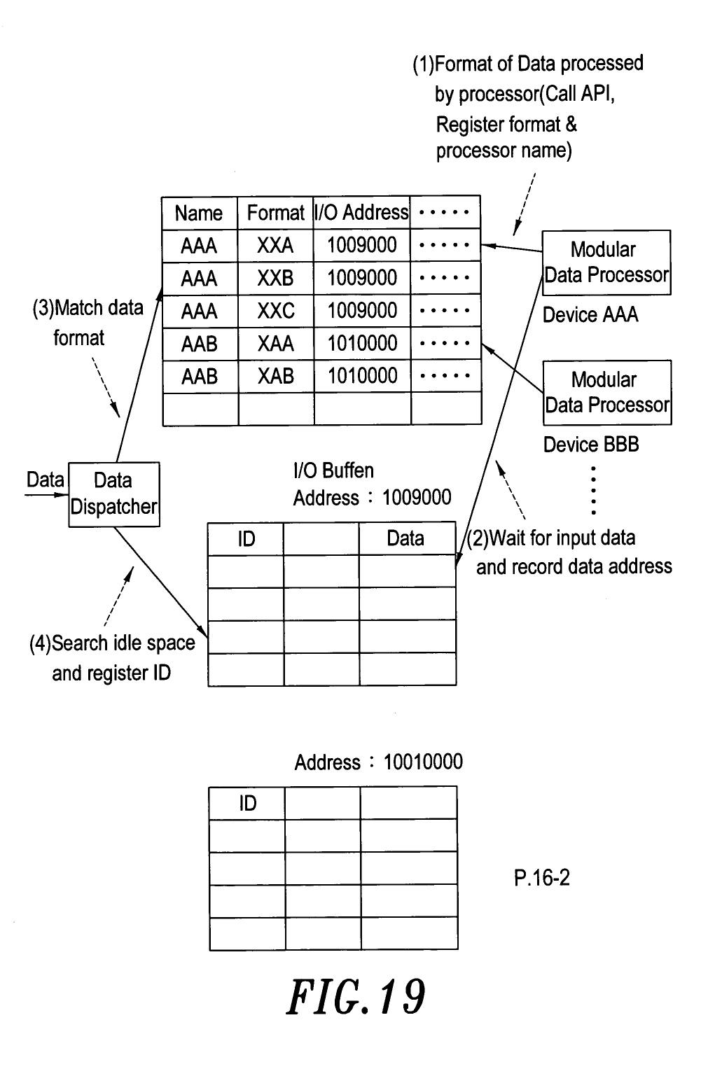

A common the TCP/IP server, primarily including IP address and server port, can generate a server program. On the contrary, in the design of the present invention, in order to control effectively the stability of the system, the user is allowed particularly to configure the communication program to handle at most data-input sessions simultaneously, such as IP:192.0.1.1, Port:8050. The general program coding manner is illustrated in FIG. 14. When receiving many records (maybe over one hundred), the conventional program coding manner is apt to cause the system becoming unstable even crash. On the contrary, if the design of the present invention is IP:192.0.1.1, Port:8050, Session:5, the coding manner used can refer to the FIG. 15. Herein the design allows the user to predetermine the maximum service count at the same time, and the system do not accept the request once the service count is over, and the system can read the outstanding data form the network only till the processing of one of records is complete,. If the system can not finish data processing in the prescribed time (Time Out), the system has a monitoring procedure that monitors the communication channels all the time such that, as soon as this situation occurs, the monitoring procedure will auto-refresh the status of the channel to be reset into the status of waiting for processing input, and receive the subsequently input data. The present design has another characteristic that the user can setup multiple to-be-booting server programs before the system startups, and then the system reads the configuration file and generate the communication servers while booting, such that the user do not need to write the communication programs, as the configuration file shown in FIG. 16. While the system boots, as shown in FIG. 17, once the communication server receiving data from the network, it will send data to the data dispatcher and establish the communication channel, as shown in FIG. 18;

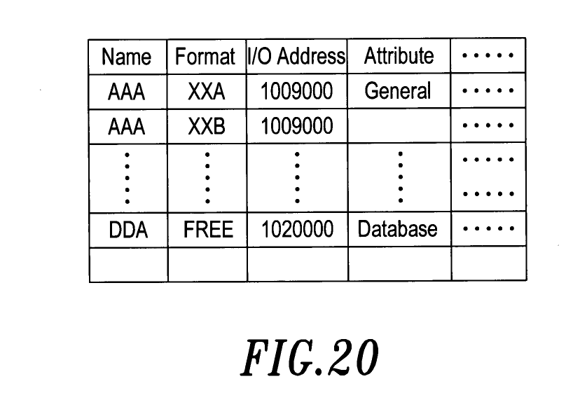

A data dispatcher 2, said data dispatcher is capable of receiving data from the communication server, dispatching the data, according to its format, to the outstanding data register corresponding with a certain modular data processor (User's Application system), as shown in FIG. 19.

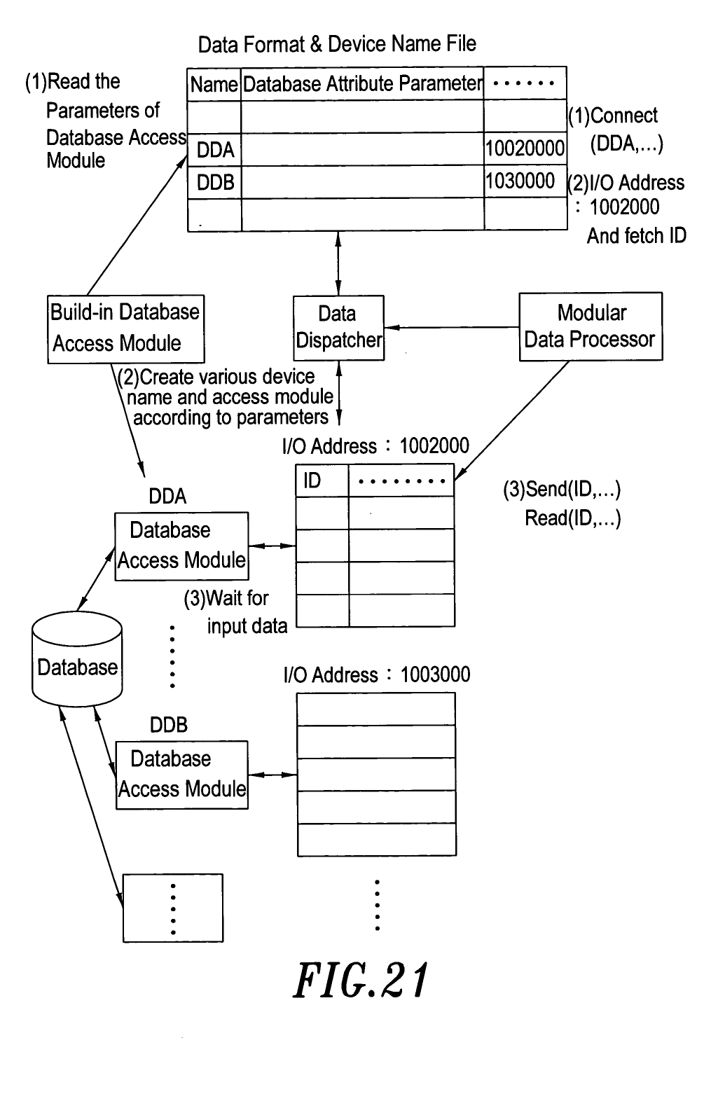

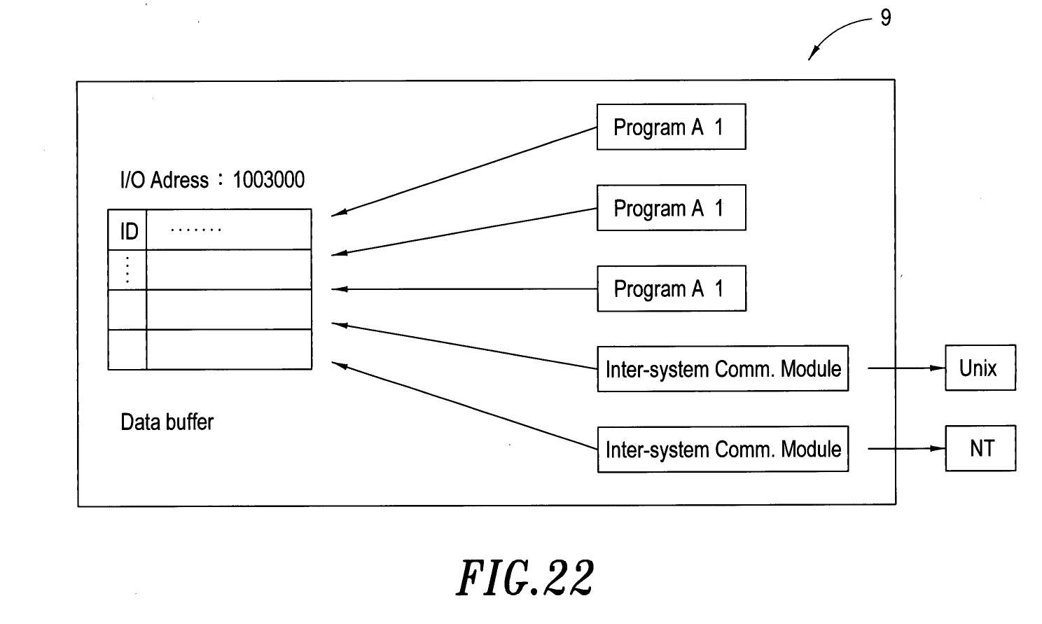

A build-in database access module 3, said database access module can be used, when the modular data processor(User's Application system) need to access the data of the database, to communicate with the external database using the build-in database access module; wherein the primary function of the database access module is to convert the name of the external database (Table) into a device name, and the user can setup the available database before the system startup to control the security of the database. Another characteristic of the system designed as such is that the modular data processor (User's Application system) can communicate with various devices using the same application system interface (API) for exchanging data and hence simplify the way of program coding, as shown in FIG. 20. While the system startup, it will load the configuration file to a memory, as shown in FIG. 21.

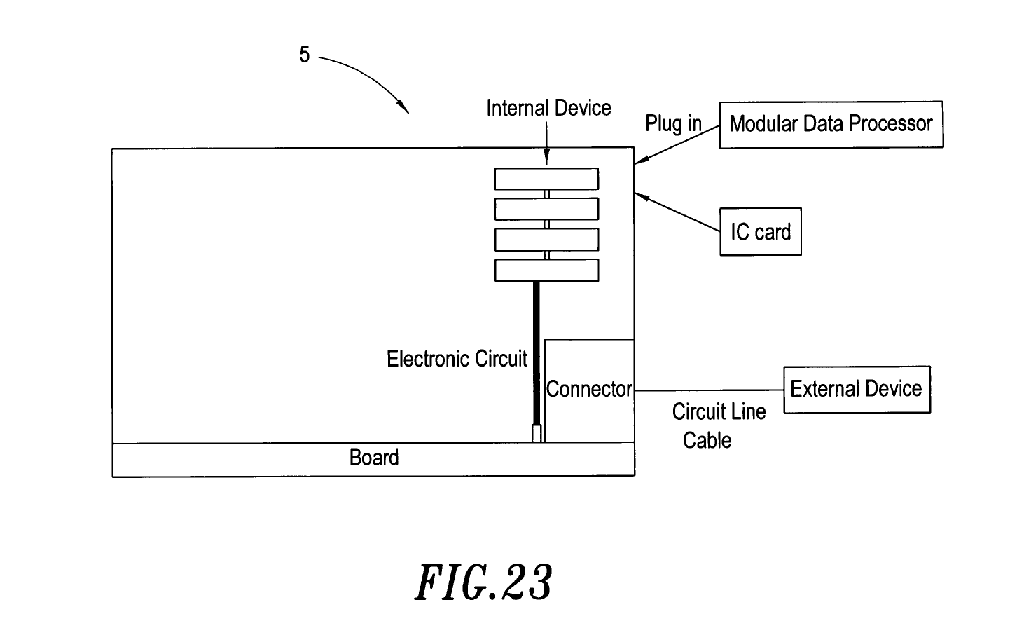

A data register 4, as shown in FIG. 22, the function designed in the data register primarily comprises:
1. Detaching each module with various functions from the modular data processor and facilitating exchanging data with each other in the presence of data registers to improve the common function of the modular data process or;
2. The independence of the modular data processor rendering the renewing, removing and integrating in the future become more flexible;
3. The function of the data register enabling the modular data processors with the same function to access data in the same address, and thus achieving the function of auto-balancing loading and mutual backup;
4. With respect to the integration capability of the processor, for modular data processors developed by various software and hardware vendors, the primary input/output data format is the only thing need to be recognized, and also can be referenced by other modular data processors even after several years; the generation of the data register is created by the system automatically by creating a block in the memory, according to the requirements recorded in the data format & the device name file, and copying the memory address of the block into the data format & device name file.

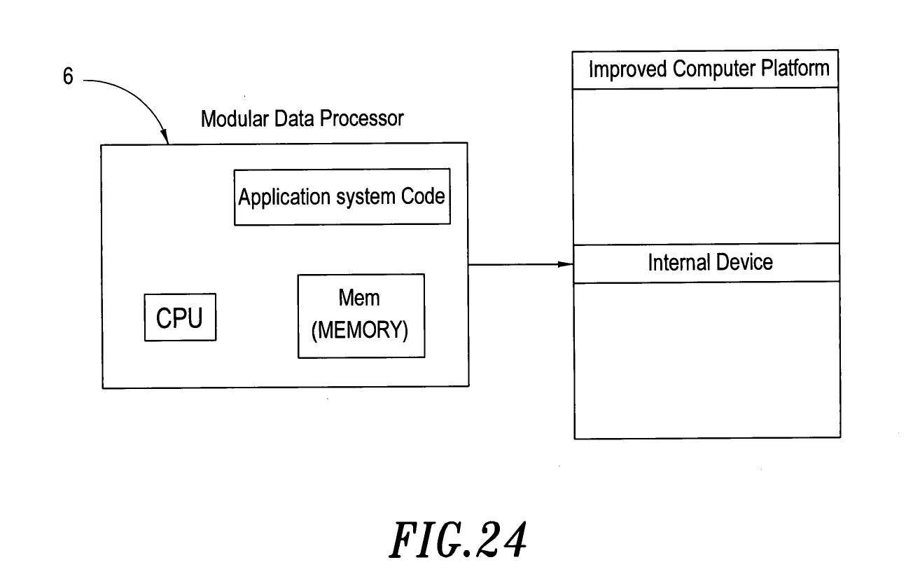

A internal & external device 5, as shown in FIG. 23, the major function of the internal & external device is to connect the modular data processor to the system, and to read the data sent from the system for carrying out the interpreting operation, and transferring data through the device and other modular data processors, or to return the result to the system; wherein, the internal device is connected directly to the board and the chassis using the electronic circuit, while the external device is designed to connect to the system using circuit lines (Cable) for future expansion.

A modular data processor 6, as shown in FIG. 24, the modular data processor contains a small-scale CPU (central processor modular) and a memory, and the user can transcribe the application program to the modular data processor for execution, and plug the modular data processor in the device for carrying out the data input and output via the device.

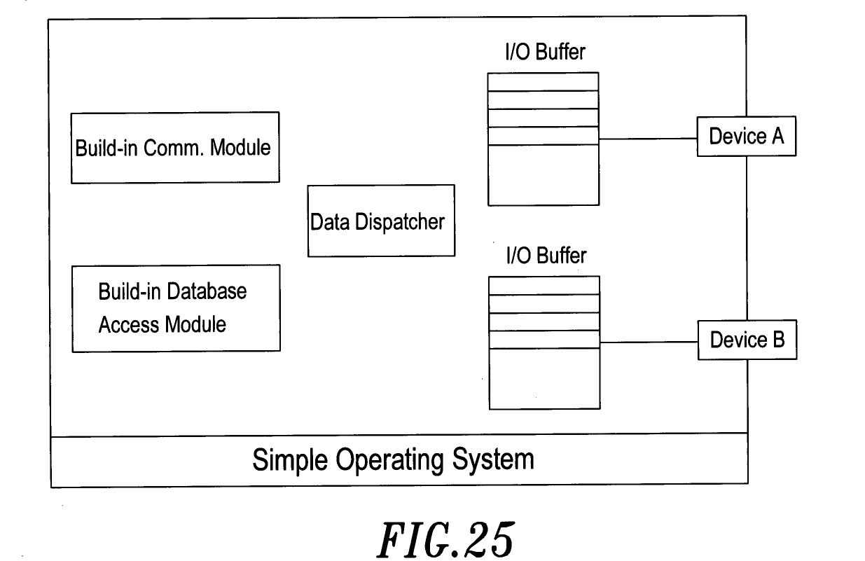

A simple operating system 7, as shown in FIG. 25, the operating system, without the complex features of the conventional operating system, just has a simple function for system startup (booting), loading the build-in modules, environment initialization (initial) and maintaining the configuration file present in the static memory.

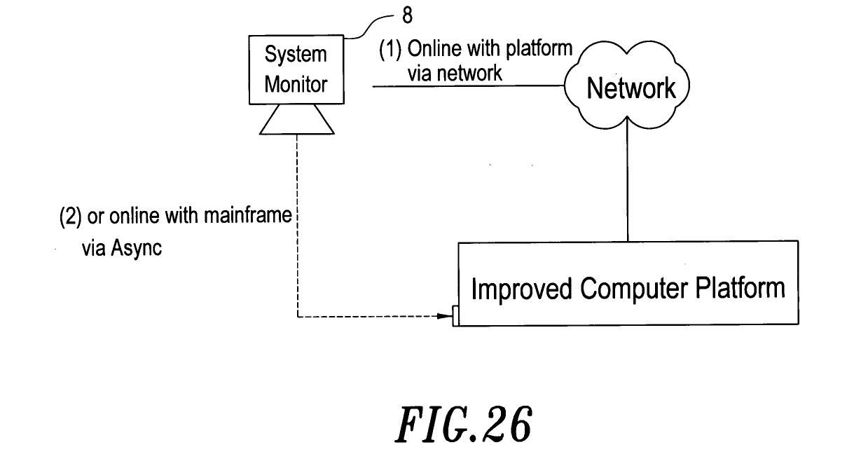

A system monitor 8, as shown in FIG. 26, the system monitor can be used to check through the internal status of the system and system devices, or to modify the configuration parameters via the system monitor tools if requires.

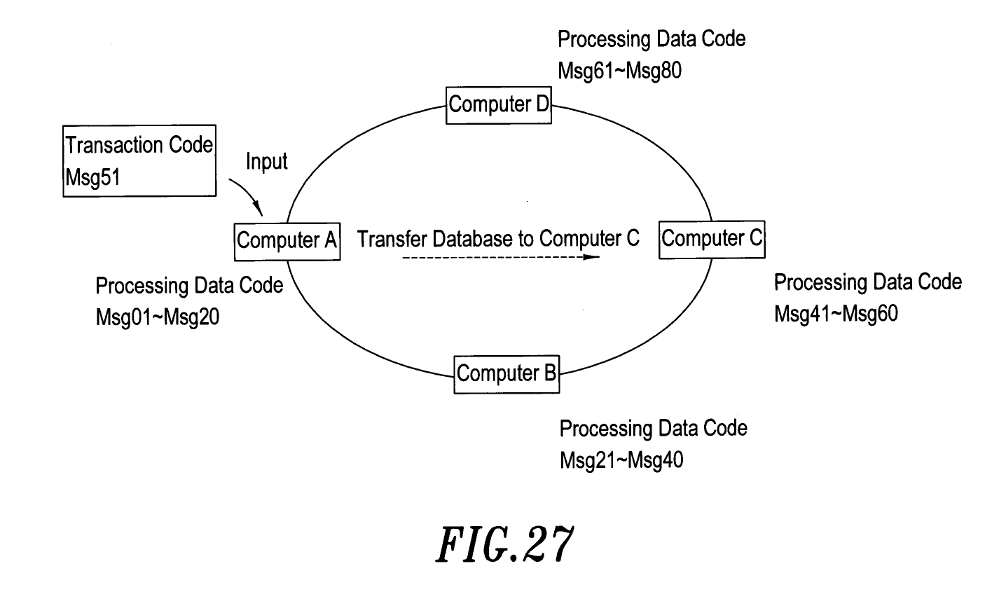

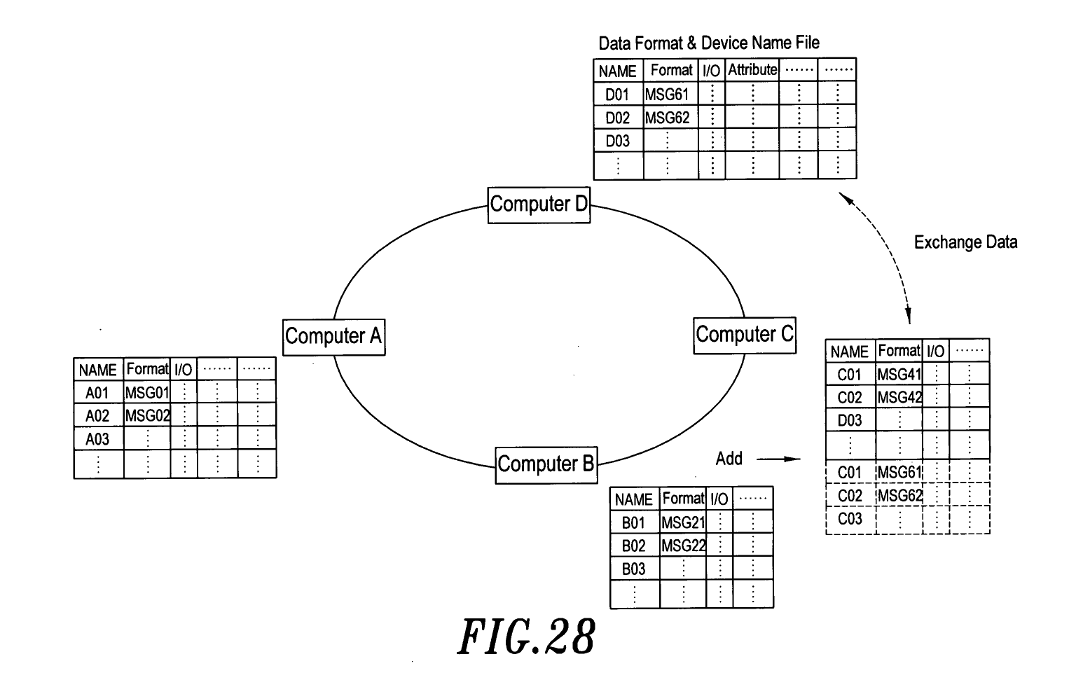

As shown in FIG. 27, the architecture diagram illustrating the implementation of the software materialization and the artificial neuron computer system according to the present invention, the primary function of the artificial neuron computer system can eliminate the obsessions of the future expansion and system integration, and enable the system change become more easy, its design is intended that any computer in the same group once receive the data un-interpretable, the computer can find out the modular data processor in the group of computers capable of interpreting the data format and processing by the function of mutual learning in the group of computers. Since the design architecture of the modular data processor of the present system can facilitate the function of the artificial neuron computer system, each computer in the group, at starting up, can exchange mutually the data format & device name file with other computers in the same group, as shown in FIG. 28. Thus, it is easy to know every computer in the group includes which kind of device and process which kind of data format, and the system actively inform each computer if any change occurs to achieve the status update. Through the above-mentioned, the present invention provides a user-friendly function such that the expansion, integration, modification, and management of the system can be more automatic.

As the software materialization platform and the artificial neuron computer system according to the present invention is compared with the above-mentioned conventional techniques, there are advantages as follows:
1. Reducing the implementation risk of the enterprise electronization;
2. Reducing substantially the expense of maintenance, management after enterprise computerization and the integration cost of system expansion in the future;
3. Promoting the stabilization of the computer system;
4. Shortening the development horizon of the software system;
5. Solving the problem of manpower requirement on technology after computerization;
6. Increasing the reusability of the software system; and
7. Promoting the willingness of the enterprise computerization.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A software materialization platform comprises:
a build-in communication module, which is a duplex communication module programmed and burned in the system EPROM, wherein parameters can be configured by the user to generate a corresponding server program for receiving the outstanding data from the network;
a data dispatcher, which receives data from the communication server, and dispatches the data according to its format to a certain modular data processor;
a build-in database access module, which is utilized, when the modular data processor need to access the data of the database, to communicate with the external database using the build-in database access module;
a data register, whose function lies primarily in detaching each module with various functions from the modular data processor and facilitating data exchange with each other in the presence of data registers to raise the common function of the modular data processor;
a internal & external device, whose major function comprises of connecting the modular data processor to the system, reading the data from the system for carrying out the interpreting operation, transferring data through the device and other modular data processors, or returning the result to the system;
a modular data processor, provided with a small-scale CPU (central processor modular) and memory, wherein the user can transcribe the application system to the modular data processor for execution, and plug the modular data processor in the device for carrying out the data input and output via the device;
a simple operating system, exhibiting no complex features associated with the conventional operating system, and comprising just a simple function for system startup, loading the build-in modules, environment initialization and maintaining the configuration file present in the static memory; and
a system monitor, for checking through the internal status of the system and system devices, or for modifying the configuration parameters via the system monitor tools if requires.

2. A software materialization platform of claim 1, wherein said protocol module of said build-in communication module includes TCP/IP, X25, ASYNC, SNA (a proprietary protocol of IBM computer product series).

3. A software materialization platform of claim 1, wherein the integration capability of the processor can be directed against the modular data processor developed by various software and hardware vendors, and the primary input/output data format is the only thing need to be recognized such that it can be referenced by other modular data processors even after several years

4. A software materialization platform of claim 1, wherein said generation of the data register is created by the system automatically by creating a block in the memory according to the requirements recorded in the data format & the device name file, and copying the memory address of the block into the data format & device name file.

5. A software materialization platform of claim 1, wherein said internal device is connected directly to the board and the chassis via the electronic circuit.

6. A software materialization platform of claim 1, wherein said external device is designed to connect to the system via circuit lines for future expansion.

7. A software materialization platform of claim 1, wherein the function of said data register enables the modular data processors with the same function to access the data in the same address, and thus achieve the functions of auto-balance load and mutual backup.

8. An artificial neuron computer system comprises a design framework in which, as any computer in the same group received an un-interpretable data, the computer can find out, from the group of computers, the modular data processor capable of interpreting the data format and processing by the function of mutual learning in the group of computers.

9. An artificial neuron computer system of claim 8, wherein each computer in the group, at starting up, exchanges mutually the data format & device name file with other computers in the same group such that it is easy to know every computer in the group including which device in each computer can process which kind of data format, and that the system actively inform every computer in the group if any change occurs to achieve the status update.
